(19) United States
(12) Patent Application Publication
(10) Pub. No.: US 2013/0063769 A1
(43) Pub. Date: Mar. 14, 2013

(54) INFORMATION MANAGEMENT APPARATUS AND METHOD, INFORMATION MANAGEMENT SYSTEM, AND NON-TRANSITORY COMPUTER READABLE MEDIUM

(71) Applicants: Shigehisa KAWABE, Kanagawa (JP); Akira SUZUKI, Kanagawa (JP); Setsu KUNITAKE, Kanagawa (JP)

(72) Inventors: Shigehisa KAWABE, Kanagawa (JP); Akira SUZUKI, Kanagawa (JP); Setsu KUNITAKE, Kanagawa (JP)

(73) Assignee: FUJI XEROX CO., LTD., Tokyo (JP)

(21) Appl. No.: 13/364,737

(22) Filed: Feb. 2, 2012

(30) Foreign Application Priority Data
Sep. 8, 2011 (JP) 2011-196387

(51) Int. Cl. G06K 15/02

(52) U.S. Cl. 358/1.15

(57) ABSTRACT

An information management apparatus includes the following elements. A generator generates a circulation document including an e-document and document identification information thereof. A job information registration section extracts and registers job information, and also specifies and registers a due date of the job. A history information registration section registers the obtained document identification information and operation history information indicating a type and a time of operation performed on the circulation document. An output section specifies document identification information associated with job information that is at least partially identical to the job information associated with the obtained document identification information and associated with operation history information indicating that a job has been completed. The output section then generates information indicating a probability that the job will be completed by the due date or a probability that the job will not be completed by the due date, and outputs the generated information.

### CROSS-REFERENCE TO RELATED APPLICATIONS

This application is based on and claims priority under 35 USC 119 from Japanese Patent Application No. 2011-196387 filed Sep. 8, 2011.

### BACKGROUND

### (i) Technical Field

The present invention relates to an information management apparatus and method, an information management system, and a non-transitory computer readable medium.

### SUMMARY

According to an aspect of the invention, there is provided an information management apparatus including the following elements. A generator converts a format of an electronic document specified by a user so as to generate a circulation document including document identification information concerning the electronic document and contents of the electronic document. A job information registration section extracts, from the electronic document, from among the contents of the electronic document, an item of information, which is set in advance as an item of information that influences a time taken to complete a job which involves handling of the circulation document corresponding to the electronic document, and registers the extracted item of information as job information, together with the document identification information concerning the electronic document in association with each other, in a job information storage section. The job information registration section also specifies a due date of the job which involves handling of the circulation document corresponding to the electronic document and registers the specified due date in the job information storage section in association with the document identification information concerning the electronic document. A history information registration section registers, upon obtaining the document identification information included in the circulation document and operation history information including information indicating a type of operation performed on the circulation document and a time of execution of the operation, the obtained document identification information and the obtained operation history information in a history information storage section in association with each other. An output section refers to the job information storage section and the history information storage section and specifies document identification information which is associated with job information that is at least partially identical to the job information associated with the obtained document identification information and which is associated with operation history information indicating that a job has been completed. The output section then generates, by using the operation history information associated with the specified document identification information, information indicating a probability that the job that involves handling of the circulation document including the obtained document identification information will be completed by the due date or a probability that the job that involves handling of the circulation document including the obtained document identification information will not be completed by the due date, and outputs the generated information.

### BRIEF DESCRIPTION OF THE DRAWINGS

Exemplary embodiment(s) of the present invention will be described in detail based on the following figures, wherein:

FIG. 1 is a block diagram illustrating an example of the configuration of an information management system;

FIG. 2 is a block diagram schematically illustrating an example of the internal configuration of a management server;

FIG. 3 illustrates an example of a form;

FIG. 4 illustrates an example of a form schema corresponding to the form shown in FIG. 3;

FIG. 5 illustrates an example of printed matter obtained as a result of printing a form;

FIG. 6 illustrates an example of data contents stored in a job information storage section;

FIG. 7 illustrates an example of data contents stored in a handling record storage section;

FIG. 8 is a flowchart illustrating an example of a process to be executed by the management server 10 in response to a request to print a form;

FIG. 9 is a flowchart illustrating an example of a process executed by a terminal when registering a handling record;

FIG. 10 is a flowchart illustrating an example of a process executed by the management server when registering a handling record;

FIG. 11 is a flowchart illustrating an example of a detailed process for calculating a due date allowance degree;

FIG. 12 illustrates examples of information records representing handling records which are used as references for calculating a due date allowance degree;

FIG. 13 illustrates an example of a frequency distribution of the values of “number of days taken to complete a job” field indicated in the information records shown in FIG. 12;

FIG. 14 illustrates other examples of information records representing handling records which are used as references for calculating a due date allowance degree;

FIG. 15 illustrates an example of a frequency distribution of the values of “number of days taken to complete a job” indicated in the information records shown in FIG. 14;

FIG. 16 illustrates still other examples of information records representing handling records which are used as references for calculating a due date allowance degree;

FIG. 17 illustrates an example of a frequency distribution of the values of “number of days taken to complete a job” indicated in the information records shown in FIG. 16;

FIGS. 18A, 18B, and 18C each illustrate a frequency distribution of the values of the number of days taken to settle written proposals which were circulated for conducting jobs in an organization; and

FIG. 19 is a block diagram illustrating an example of the hardware configuration of a computer.

### DETAILED DESCRIPTION

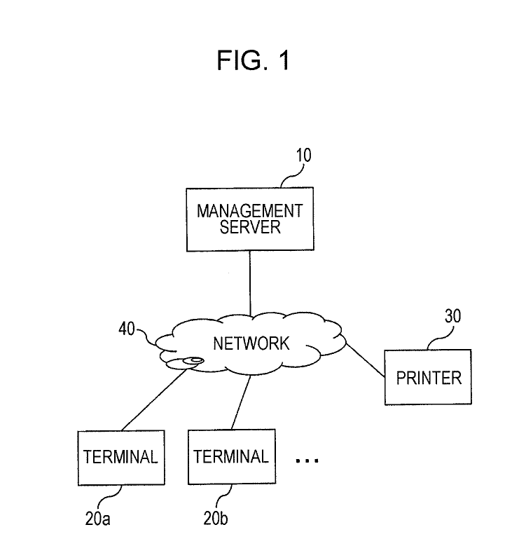

FIG. 1 illustrates an example of the configuration of an information management system that manages jobs that involve handling of documents. The information management system shown in FIG. 1 includes a management server 10, terminals 20a, 20b, etc., and a printer 30 that are connected to one another via a network 40.

The management server 10 manages information concerning jobs and information concerning documents handled in jobs. The management server 10 serves as an information management apparatus of an exemplary embodiment of the invention. Details of the management server 10 will be given later.

The terminals 20a, 20b, etc., (hereinafter referred to as the “terminal 20” or “terminals 20”) are client terminals that perform operations on documents or request the management server 10 to perform processing in response to an input from a user. The terminal 20 may be an information processing apparatus, such as a general-purpose computer.

The printer 30 is a printing apparatus that prints electronic documents in response to a print instruction given by the management server 10 or the terminal 20. The network 40 is a communication medium, such as a local area network (LAN) or the Internet.

A job managed by the information management system shown in FIG. 1 is carried out through circulation of a document concerning the job among plural operators (users). Each operator receives the document and works on the document assigned to that operator, and then passes the document to another operator. Documents to be circulated may be documents printed on a medium, such as paper. Alternatively, documents may be electronic documents that are created in a predetermined format, such as a circulation file format, in an organization that carries out a job. An exemplary embodiment of the invention will be described below by taking, by way of example, a case in which a job is carried out through circulation of a document printed on paper (paper document). In the following description, documents handled in jobs may also be referred to as “forms”.

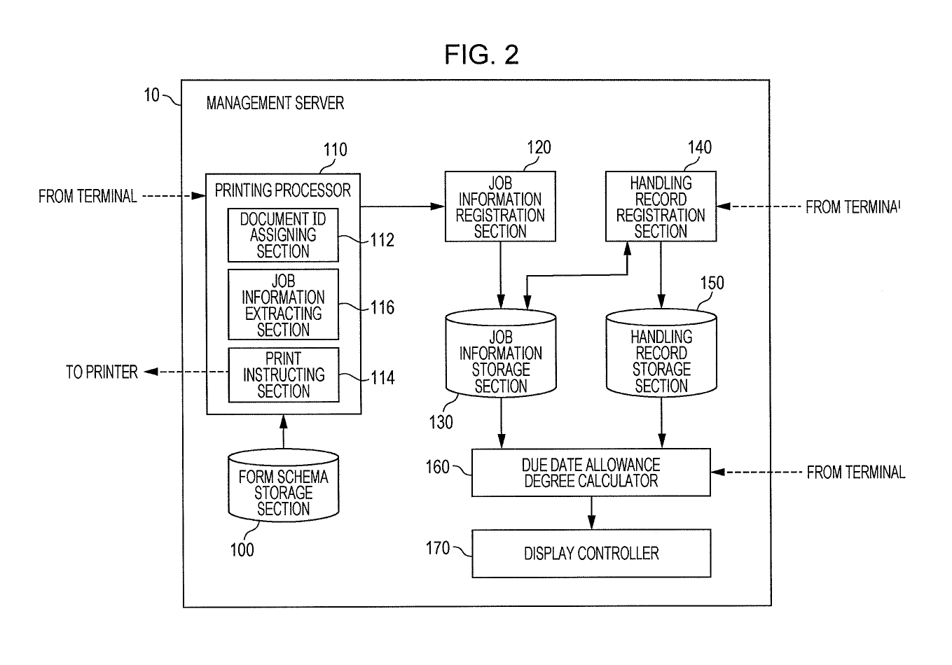

The management server 10 will be described below in detail with reference to FIG. 2. FIG. 2 is a block diagram schematically illustrating an example of the internal configuration of the management server 10. The management server 10 shown in FIG. 2 includes a form schema storage section 100, a printing processor 110, a job information registration section 120, a job information storage section 130, a handling record registration section 140, a handling record storage section 150, a due date allowance degree calculator 160, and a display controller 170.

The form schema storage section 100 stores form schemas, which are items of information indicating layouts of various forms. In an example of this exemplary embodiment, a form is created in accordance with a format which has been determined depending on the type of form. Accordingly, form schemas are defined for individual types of forms, and are registered in advance in the form schema storage section 100. For example, a form schema of a certain type of form may describe what kind of information is disposed in which area in that type of form. A form schema is checked when a job information extracting section 116 (which will be described later) of the printing processor 110 extracts information from a form to be printed. Thus, the form schema does not have to indicate the arrangement of all items of information contained in the form as long as it indicates the arrangement of information to be extracted by the job information extracting section 116 in the form.

In the example of this exemplary embodiment, information to be extracted by the job information extracting section 116 is information that may influence the time taken to finish a job which involves handling of a form. For example, depending on a route through which a form will be circulated, the number of users doing work on a form handled in job and the departments of such users may differ. Accordingly, the time taken to finish a job which involves handling of a form may differ depending on the route of circulation of the form. Thus, in the example of this exemplary embodiment, among information items concerning a form, information concerning a decision about a route of circulation of the form is to be extracted by the job information extracting section 116. In the following description, an information item to be extracted by the job information extracting section 116 is also referred to as a “risk parameter”.

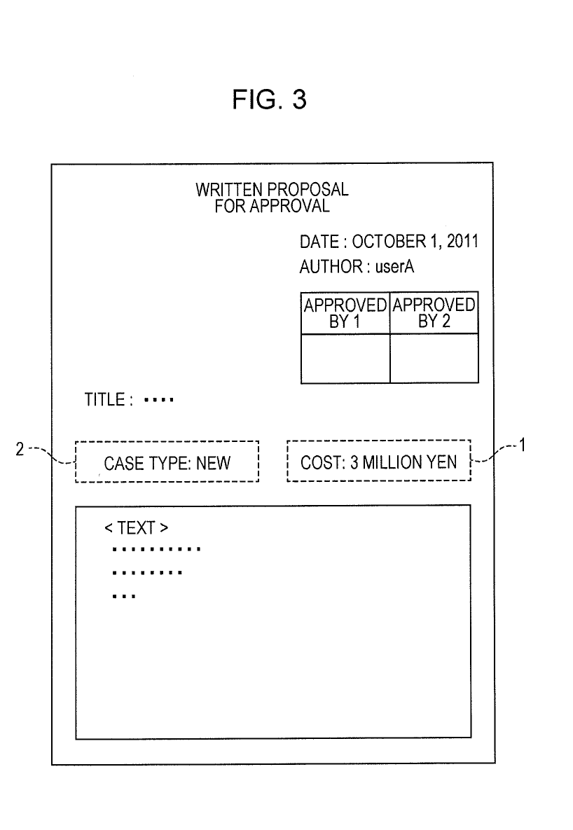

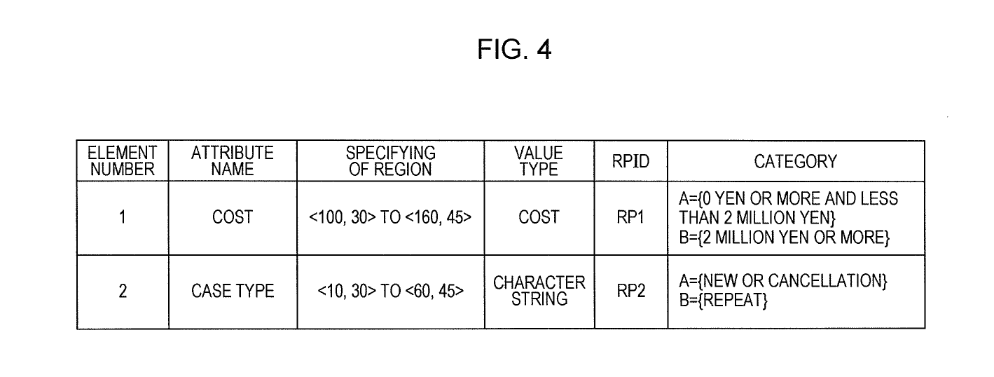

FIG. 3 illustrates an example of a form, and more specifically, an example of a written proposal for approval to be circulated when carrying out a job in an organization, such as a company or a municipality. The form shown in FIG. 3 includes sections for the date and the author, columns for seals for approval, and sections for the title, case type, cost, and text. FIG. 4 illustrates an example of a form schema corresponding to the form shown in FIG. 3. The form schema shown in FIG. 4 indicates the arrangement of risk parameters to be extracted by the job information extracting section 116 among information items contained in the form shown in FIG. 3. The table shown in FIG. 4 includes fields, such as the item number, attribute name, specifying of region, value type, RPID, and category. The item numbers 1 and 2 are associated with rectangular regions 1 and 2 surrounded by the broken lines in FIG. 3. The attribute name represents the name appended to each of the rectangular regions associated with the item numbers 1 and 2. In the example shown in FIG. 4, the item names, i.e., “cost” and “case type”, of information described in the rectangular regions 1 and 2 in the form are used as the attribute names. The route of circulation of the form may differ depending on the cost and the type of case to be approved. Accordingly, in the form shown in FIG. 3, the cost and the case type are risk parameters. The “specifying of region” field represents rectangular regions in the form associated with the item numbers 1 and 2. The values in the “specifying of region” field include the coordinate values of the top left and the coordinate values of the bottom right of each rectangular region. The coordinate values <x, y> shown in FIG. 4 are values, assuming that the corner at the top left of the form is set to be <0, 0> and the direction from the left to the right is the x axis and the direction from the top to the bottom is the y axis. The “value type” field is the type of value extracted from the rectangular regions associated with the item numbers 1 and 2 by the job information extracting section 116. In the example shown in FIG. 4, the “cost” is extracted from the rectangular region associated with the item number 1, while the “character string” is extracted from the rectangular region associated with the item number 2. The “RPID” field represents identification (ID) information concerning risk parameters associated with the item numbers 1 and 2. The “category” field represents conditions for classifying forms in accordance with the values extracted from the rectangular regions associated with the item numbers 1 and 2. For example, the “category” field of the item number 1 shows the following conditions for classification. If the value of the “cost” extracted from the rectangular region associated with the item number 1 of the form is 0 yen or more and less than two million yen, the category of the risk parameter “cost” is classified as A, and if the value of the “cost” is two million yen or more, the category of the risk parameter “cost” is classified as B. Additionally, for example, the “category” field of the item number 2 shows the following conditions for classification. If the value of the “character string” extracted from the rectangular region associated with the item number 2 of the form is “new” or “cancellation”, the category of the risk parameter “case type” is classified as A, and if the value of the “character string” is “repeat”, the category of the risk parameter “case type” is classified as B.

Referring back to a description of FIG. 2, in response to a request to print an electronic form from the terminal 20, the printing processor 110 performs processing for printing the electronic form on paper. An electronic form (also referred to as an “e-form”) is formed in the terminal 20 in response to an instruction from a user. The user may form an e-form by writing information into a template e-document that is used for determining a desired form format by using a document editing application provided in the terminal 20. A template e-document is formed in advance for each form type, and is stored in a storage device (not shown) which is accessible from the terminal 20. In response to an instruction to print an e-form from a user through the use of the terminal 20, the terminal 20 sends a print request to print the e-form to the management server 10. It is assumed that the print request contains information concerning the type of e-form, together with electronic data representing the e-form to be printed. Upon receiving the print request, the printing processor 110 of the management server 10 instructs the printer 30 to print the e-form and a document ID on paper. The document ID is ID information for identifying the e-form to be printed. The printing processor 110 includes a document ID assigning section 112, a print instructing section 114, and the job information extracting section 116.

The document ID assigning section 112 generates a document ID for identifying an e-form to be printed and assigns the document ID to the e-form. The document ID is an ID that uniquely identifying an e-form among e-forms managed by the management server 10. For example, the document ID assigning section 112 may generate a universally unique identifier (UUID) and use it as the document ID.

The print instructing section 114 instructs the printer 30 to print on paper an e-form to be printed and a document ID assigned to the e-form by the document ID assigning section 112. In this case, in an example of this exemplary embodiment, the print instructing section 114 instructs the printer 30 to convert the document ID into a computer readable code and to print the converted document ID. Examples of codes representing the document ID are linear codes, such as barcodes, and two-dimensional codes, such as Quick Response (QR) codes. In accordance with the instruction from the print instructing section 114, the printer 30 outputs a paper document (paper form) on which the e-form is printed together with the document ID.

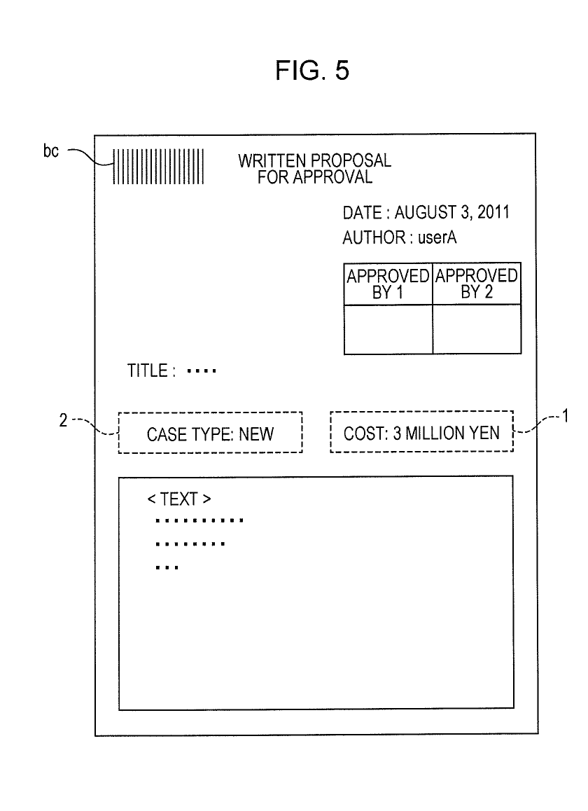

An example of a paper document on which the e-form shown in FIG. 3 is printed in response to an instruction from the print instructing section 114 is shown in FIG. 5. On the paper form shown in FIG. 5, a barcode be representing the document ID of the e-form shown in FIG. 3 is printed.

The job information extracting section 116 refers to a certain form schema stored in the form schema storage section 100, and extracts the values of risk parameters indicated by the form schema from data representing the form to be printed. For example, the job information extracting section 116 reads the form schema corresponding to the type of form to be printed from the form schema storage section 100, and extracts the values of information indicated in regions described in this form schema. Data representing a form to be printed is described in a format suitable for performing printing processing by the printer 30, and is described in, for example, a page description language (PDL). The job information extracting section 116 interprets data representing a form described in, for example, a PDL, and specifies information which is indicated in each of the regions described in the form schema and which corresponds to the “value type” described in the form schema. Then, the job information extracting section 116 extracts the specified information as risk parameters for the regions. An example of a method for extracting form data will be discussed below. Generally, when drawing text on a form by using a PDL, a text drawing command is used. In some text drawing commands, drawing start coordinates (X, Y) and a drawing character string are specified as arguments. In a form schema, a region to be extracted is specified as a rectangular region, and as a parameter indicating the rectangular region, four coordinate values are specified in the format of <left, top> through <right, bottom>. The individual coordinate values represent the coordinate values of the left edge, top edge, right edge, and bottom edge of a rectangular region, as indicated in the “specifying of region” field shown in FIG. 4. From among drawing commands to be executed for one page of a form, a text drawing command for which the drawing start coordinates (X, Y) are contained in a coordinate range representing a rectangular region specified by the form schema is specified. Then, the drawing character string, which is an argument of the specified text drawing command, is extracted as information specified for the rectangular region. The job information extracting section 116 supplies, together with the document ID of the form, the values of the risk parameters extracted from the data representing the form to the job information registration section 120. If a “category” field is described in accordance with the values of the risk parameters, as in the example shown in FIG. 4, the job information extracting section 116 refers to the “category” field provided in the form schema and specifies the category corresponding to the value of each of the risk parameters extracted from the data representing the form. If the categories for the risk parameters are specified, the job information extracting section 116 also supplies the specified categories to the job information registration section 120. In the following description, the values of risk parameters extracted from data representing a form and categories corresponding to the values of the risk parameters may also be referred to as the “job information”.

The job information registration section 120 receives job information extracted from data representing a form to be printed and registers the job information in the job information storage section 130. For example, the job information registration section 120 registers the values of risk parameters extracted from the data representing the form by the job information extracting section 116 in the job information storage section 130 in association with the document ID assigned to the form to be printed by the document ID assigning section 112. If the job information extracting section 116 has specified a category for each of the risk parameters, the job information registration section 120 also registers the specified categories in the job information storage section 130 in association with the document ID.

The job information registration section 120 also registers a due date of the circulation of a paper form appended with a document ID, i.e., a due date on which a job which involves handling of the paper form will be completed, in the job information storage section 130 in association with the document ID. A rule concerning the decision of a due date is set for each type of form in advance, and the due date is decided in accordance with the rule corresponding to the type of form appended with a document ID to be registered. Examples of the rule concerning the decision of a due date are “X days after a date on which a paper form is printed” and “Y weeks after a date on which a paper form is printed”. Alternatively, a user of the terminal 20 that makes a print request to print a form may input a due date of a job which involves handling of the form, and resister the input due date in the job information storage section 130 in association with the document ID of the form. If the user is to input a due date, the job information registration section 120 sends information indicating an instruction for the user to input a due date to the terminal 20 which has made a print request, and the terminal 20 displays that information. Then, the job information registration section 120 obtains the due date input by the user. Alternatively, an input column for a due date may be provided in an e-form format, and a “specifying of region” field may be described in a form schema so that the value of a due date is extracted. In this case, the job information extracting section 116 extracts a due date together with other job information items from the data representing a form, and the job information registration section 120 registers the extracted due date in the job information storage section 130.

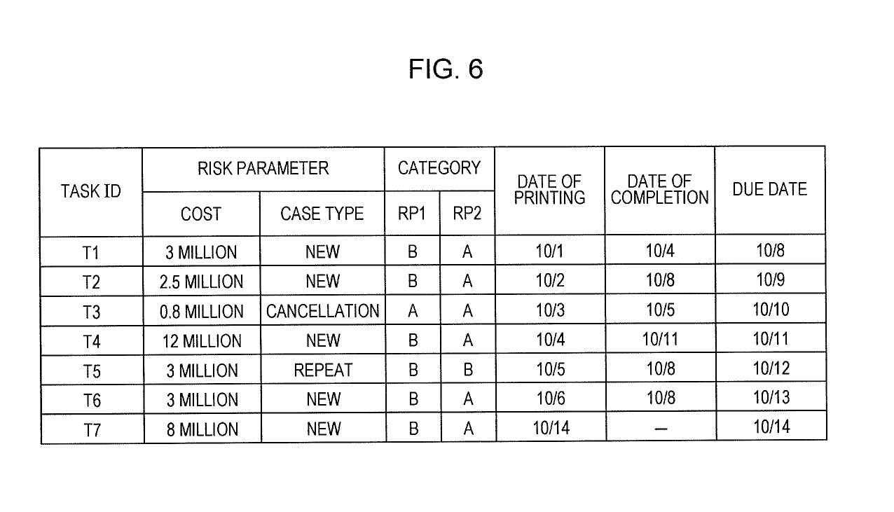

The job information storage section 130 serves as a storage section for storing job information obtained from each form. FIG. 6 illustrates an example of data contents stored in the job information storage section 130.

FIG. 6 illustrates an example of data contents of job information extracted in accordance with the form schema shown in FIG. 4 from data representing plural forms described in the same format as that of the written proposal for approval shown in FIG. 3. The data contents shown in FIG. 6 are registered in the job information storage section 130. The table shown in FIG. 6 includes fields, such as the task ID, risk parameter, category, date of printing, date of completion, and due date. The task ID is ID information concerning a case of a job which involves handling of a form. In the example of this exemplary embodiment, one form is used for one case, and the document ID of a form is used as the task ID. The “risk parameter” field indicates the value of a risk parameter extracted from a form to which a certain task ID is assigned. In the example shown in FIG. 6, the “risk parameter” field includes two sub-items, i.e., the cost and the case type. The cost and the case type respectively correspond to the values extracted from the rectangular regions 1 and 2 of the form shown in FIG. 3. The “category” field represents a category when forms are classified in accordance with the values of the corresponding risk parameters, as indicated in the form schema shown in FIG. 4. In the example shown in FIG. 6, the category concerning the cost (risk parameter ID information RPID=RP1) and the category concerning the case type (RPID=RP2) are indicated. The “date of printing” field indicates a date on which a form having a certain task ID was printed. The date of printing may also be considered as a date on which a paper form was formed. As the value of the “date of printing” field, a date on which the job information registration section 120 received job information concerning a form from the job information extracting section 116 of the printing processor 110 may be set. The “date of completion” field indicates a date on which a job which involves handling of a form having a corresponding task ID was completed. The value of the “date of completion” field is still blank when a form was printed and job information concerning that form was registered in the job information storage section 130. Processing for registering a value of the “date of completion” field will be discussed later. The “due date” field indicates a due date on which a job that involves handling of a form having a certain task ID will be completed. The value of a due date is specified by using the job information registration section 120 in accordance with one of the above-described decision rules. In the example shown in FIG. 6, each value in the “due date” field has been decided in accordance with a rule “seven days after a date on which a form was printed”.

As a result of the above-described processing performed by the printing processor 110 and the job information registration section 120, a form appended with a document ID (see FIG. 5) is printed, and also, job information extracted from print data representing each form is registered in the job information storage section 130. The form printed by using the printer 30 in accordance with an instruction from the print instructing section 114 of the printing processor 110 is circulated among operators to which individual job steps of a job that involves handling of the form are assigned. Upon receiving the form, an operator instructs the management server 10 to register a history of an operation performed on the form by using the terminal 20 of the operator. For example, the operator causes the terminal 20 to read a code representing a document ID printed on the form by using a reader (not shown) connected to the terminal 20. The reader may be a reading device compatible with the specifications of the code representing the document ID. For example, if the code representing the document ID is a barcode, a barcode reader may be used. If the code representing the document ID is a QR code, a QR code reader may be used. After causing the terminal 20 to read the document ID, the operator inputs information indicating the type of operation performed or to be performed on the form into the terminal 20, and also instructs the management server 10 to register an operation history including information indicating the type of operation into the management server 10. In the example of this exemplary embodiment, information indicating the type of operation is input as follows. A list of job steps that may be performed for a job which involves handling of a form is displayed in a display device (not shown) of the terminal 20, and then, the operator selects a job step corresponding to an operation assigned to the operator from this list. Upon input of an instruction to register an operation history, the terminal 20 sends an operation history including the document ID read by the reader, the type of operation, and the date of operation to the management server 10. The date of operation may be a current date obtained from the system clock of the terminal 20.

A description will be given referring back to FIG. 2. The handling record registration section 140 of the management server 10 receives an operation history sent from the terminal 20, as described above, and registers the received operation history in the handling record storage section 150. In the example of this exemplary embodiment, an operation history concerning a form is also referred to as a “handling record”. In the example of this exemplary embodiment, upon an operator completing performing of an operation corresponding to one job step of a job for a form, the operator passes the form to another operator to which another job step of the job is assigned, and upon receiving the form, the operator performs an operation corresponding to the job step assigned to the operator. Accordingly, a history of an operation performed on a form may be considered as a record indicating that the form has been handled through an operation of a job step.

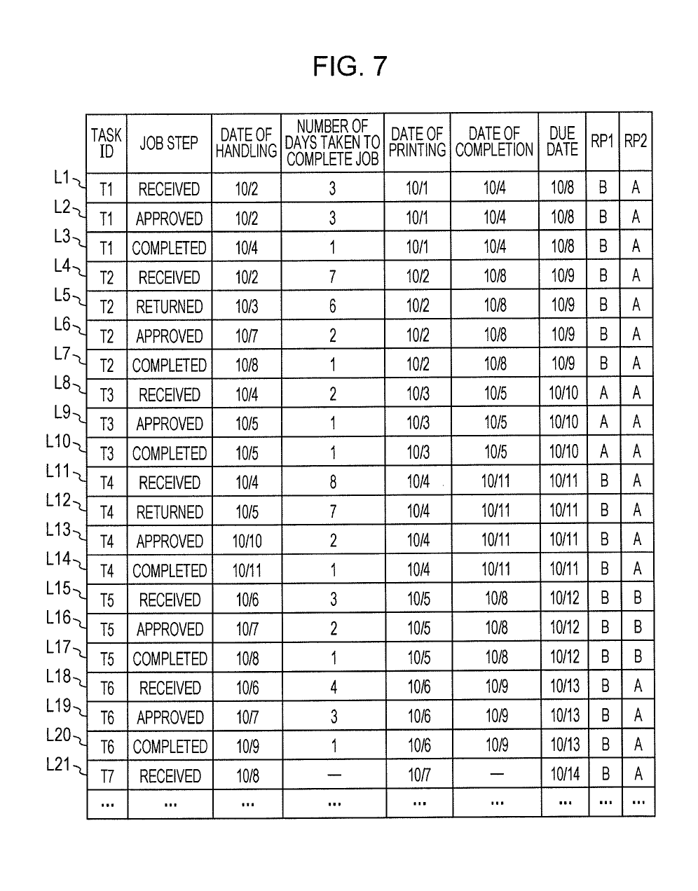

FIG. 7 illustrates an example of data contents stored in the handling record storage section 150. In the example shown in FIG. 7, data contents reflecting the data contents shown in FIG. 6 stored in the job information storage section 130, and more specifically, data contents of handling records of forms having task IDs “T1” through “T7” registered in the handling record storage section 150, are shown. The table shown in FIG. 7 includes fields, such as the task ID, job step, date of handling, number of days taken to complete a job, date of printing, date of completion, due date, RP1, and RP2. Each row of the table shown in FIG. 7 represents an information record indicating a history of one operation performed on one form. The task ID is ID information concerning a case of a job which involves handling of a form, as in the task ID of an example of the data contents stored in the job information storage section 130 discussed with reference to FIG. 6. In this example, the task ID is the document ID of a form. The “job step” field indicates a type of operation contained in an operation history sent from the terminal 20. The “date of handling” field indicates a date of an operation contained in an operation history sent from the terminal 20. The “number of days taken to complete a job” indicates the number of days taken from the date of handling of a certain information record to the date of completion indicated in the same information record. The value of the “number of days taken to complete a job” field remains blank until a job which involves handling of a form is completed (see an information record corresponding to the task ID “T7”). The “date of printing” field indicates a date on which a form with a task ID of a certain information record was printed. The “date of completion” field indicates a date on which a job that involves handling of a form with a task ID of a certain information record was completed. The value of the “date of completion” field remains blank until a job which involves handling of a certain form is completed (see an information record corresponding to the task ID “T7”). The “due date” field indicates a due date on which a job that involves handling of a form with a task ID of a certain information record will be completed. RP1 and RP2 indicate categories of a risk parameter (cost) of RPID “RP1” and a risk parameter (case type) of RPID “RP2”, respectively. In the table shown in FIG. 7, the values of the fields, such as date of printing, date of completion, due date, RP1, and RP2, are set to be the same values as those of the fields (see FIG. 6) registered in the job information storage section 130 in association with the corresponding task IDs.

A description will now be given, with reference to information records with the task ID “T1” in lines L1, L2, and L3 shown in FIG. 7, of an example of registration of a handling record performed by the handling record registration section 140. Upon receiving a handling record including the document ID “T1”, the type of operation “received”, and the date of operation “October 2” from the terminal 20, the handling record registration section 140 generates a new information record corresponding to the received handling record. Then, the handling record registration section 140 sets values of the received handling record into the new information record, and more specifically, the handling record registration section 140 sets the value of the document ID to the task ID, the value of the type of operation to the job step, and the value of the date of operation to the date of handling (see line L1). The handling record registration section 140 also checks for another information record having the same task ID “T1” as that of the information record in the line L1 in the handling record storage section 150. At the time when the record information of the line L1 is being registered in the handling record storage section 150, there is no information record having the same task ID “T1”. In this case, the handling record registration section 140 refers to the job information storage section 130 and reads the values of fields, such as the date of printing, due date, RP1, and RP2, and sets the read values as the values of the corresponding fields in the information record in the line L1, which is currently being registered in the handling record storage section 150. For example, if the data contents shown in FIG. 6 are stored in the job information storage section 130, the date of printing “October 1”, the due date “October 8”, RP1 “B”, and RP2 “A” are registered in the information record in the line L1 shown in FIG. 7. At this time, the values of fields, such as the number of days taken to complete a job and the date of completion, of the information record in line L1 are still blank.

Then, upon receiving a handling record including the document ID “T1”, the type of operation “approved”, and the date of operation “October 2” from the terminal 20, the handling record registration section 140 sets the same values as those of fields contained in the received handling record, as the task ID, job step, and date of handling of an information record (see line L2). The handling record registration section 140 then registers such an information record in the handling record storage section 150. In this case, another information record (line L1) having the same task ID “T1” as that of the information record (line L2) has already been stored in the handling record storage section 150. Thus, the handling record registration section 140 copies the values of the date of printing “October 1”, the due date “October 8”, RP1 “B”, and RP2 “A” from the information record of the line L1, and sets the copied values in the information record of line the L2, which is currently being registered in the handling record storage section 150. At this time, the values of fields, such as the number of days taken to complete a job and date of completion, of the information record in line L2 are blank.

Upon receiving a handling record including the document ID “T1”, the type of operation “completed”, and the date of operation “October 4” from the terminal 20, the handling record registration section 140 registers an information record (line L3) corresponding to the received handling record in the handling record storage section 150, as in the case of the lines L1 and L2 as described above. The handling record registration section 140 then sets the values of fields, such as the number of days taken to complete a job and the date of completion, in the information record of the line L3. In this example, the job step “completed” is a step indicating that the job which involves handling of the form with the task ID has been completed. When registering the handling record having the job step “completed”, the handling record registration section 140 sets the value of the “date of completion” field of each of the information records of all the handling records of the task ID “T1” in the value of the “date of handling” of the job step “completed”. In the case of the task ID “T1” in this example, the value (October 4) of the “date of completion” field of each of the information records of the lines L1, L2, and L3 is set in the value of the “date of handling” field of the job step “completed” in the line L3. Then, concerning each of all the handling records of the task ID “T1”, the number of days taken from the date of handling to the date of completion is calculated and is set as the value of the “number of days taken to complete a job” field of each information record. In the lines L1 and L2, the number of days “3” taken from the date of handling “October 2” to the date of completion “October 4” is set as the value of the “number of days taken to complete a job” field in the corresponding information records. In the line L3, the number of days “1” taken from the date of handling “October 4” to the date of completion “October 4” is set as the value of the “number of days taken to complete a job” field in the corresponding information record.

After registering, in the handling record storage section 150, the values of the number of days taken to complete a job and the date of completion of the information records (lines L1, L2, and L3) including the task ID “T1”, the handling record registration section 140 also registers the value of the date of completion in the job information storage section 130 in association with the task ID “T1”. For example, in the table shown in FIG. 6, the value of the date of completion associated with the task ID “T1” is set to be “October 4”.

As in the example discussed with reference to the lines L1, L2, and L3 shown in FIG. 7, handling records of the task IDs “T2” through “T7” shown in FIG. 7 are registered in the handling record storage section 150, and also, after registering a handling record of the job step “completed”, the number of days taken to complete a job is calculated and is registered together with the date of completion.

Referring back to FIG. 2, details of the due date allowance degree calculator 160 will be given. The due date allowance degree calculator 160 refers to the handling record storage section 150 and calculates a due date allowance degree indicating the probability that a job which involves handling of a specific form will be completed by a due date. For example, the due date allowance degree calculator 160 calculates a due date allowance degree for a job which involves handling of a specific form, at least at a time point when a form is printed or when a handling record is registered. In the example of this exemplary embodiment, in calculation of a due date allowance degree, the due date allowance degree calculator 160 first selects forms which satisfy conditions that at least one of the category of a risk parameter and a job step which has been executed is the same as those of the specific form, and reads from the handling record storage section 150, among handling records of the selected forms, handling records of forms for which an associated job has been completed. Then, the due date allowance degree calculator 160 calculates a due date allowance degree for the specific form by using the value of the “number of days taken to complete a job” field contained in the read handling record and the number of days from a current date to a due date of the job which involves handling of the specific form. The due date allowance degree calculator 160 may calculate plural due date allowance degrees for the specific form by changing conditions for selecting handling records which are used as references for calculating a due date allowance degree. For example, as in the examples shown in FIGS. 3 through 7, if there are plural risk parameters, the due date allowance degree calculator 160 may calculate due date allowance degrees by referring to handling records of forms which satisfy conditions that the category of each of the risk parameters is the same as that of a specific form. The due date allowance degree calculator 160 may also calculate a due date allowance degree by referring to handling records of forms which satisfy conditions that the categories of all the risk parameters are the same as those of the specific form. The due date allowance degree calculator 160 may change conditions for selecting handling records which are used as references in response to an instruction from a user. A specific example of conditions for selecting handling records which are used as references and a specific procedure for calculating a due date allowance degree will be discussed later. The due date allowance degree calculator 160 supplies the calculated due date allowance degree to the display controller 170.

The display controller 170 performs control so that a result of calculation obtained by the due date allowance degree calculator 160 is displayed in a display device (not shown). For example, the display controller 170 generates display control information used for displaying a due date allowance degree calculated by the due date allowance degree calculator 160 in the display device of the terminal 20. The display controller 170 sends the generated display control information to the terminal 20 which has made a request to print a specific form or to the terminal 20 which has sent a handling record of the specific form to the management server 10. Upon receiving the display control information, the terminal 20 displays the due date allowance degree in the display device of the terminal 20 in accordance with the received display control information.

Examples of the configuration of the information management system including the management server 10 have been discussed, and also, an overview of examples of registration and usage of various items of information concerning forms in the information management system has been discussed. A description will now be given of an example of a process to be executed by the information management system.

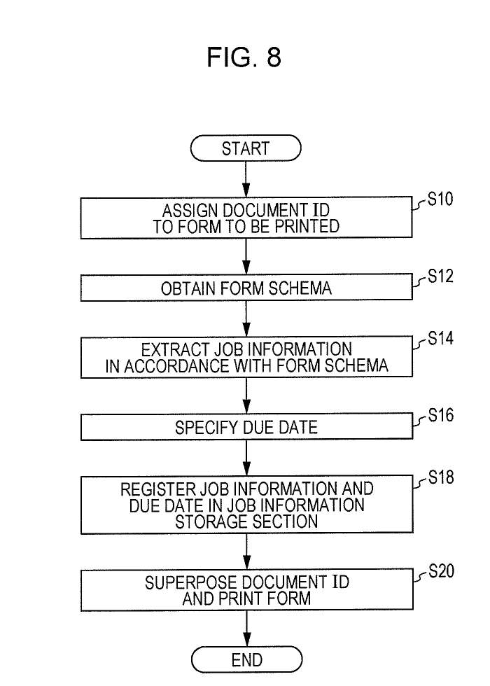

FIG. 8 is a flowchart illustrating an example of a process to be executed by the management server 10 that has received a request to print a form from the terminal 20. Upon receiving a request to print a form from the terminal 20, the management server 10 starts processing shown in FIG. 8 by way of example. A request to print a form includes data representing an e-form and information indicating the type of form.

Referring to the flowchart of FIG. 8, in step S10, the document ID assigning section 112 of the printing processor 110 assigns a document ID to a form to be printed. In this example, the document ID assigning section 112 generates a UUID for a form to be printed and sets the generated UUID as the document ID of the form. The document ID assigning section 112 supplies the document ID assigned to the form to the job information registration section 120.

In step S12, the job information extracting section 116 of the printing processor 110 obtains a form schema corresponding to the type of form to be printed from the form schema storage section 100. As a specific example, it is assumed that the form to be printed is a form in the same format as that of a written proposal for approval shown in FIG. 3 and that the form schema shown in FIG. 4 corresponding to this type of form is obtained.

Then, in step S14, the job information extracting section 116 extracts job information from data representing the form to be printed in accordance with the form schema obtained in step S12. For example, the job information extracting section 116 interprets data representing the form to be printed, and extracts the values of “cost” and “character string” within rectangular regions (corresponding to the rectangular regions 1 and 2 surrounded by the broken lines shown in FIG. 3) of the item numbers 1 and 2, respectively, described in the form schema shown in FIG. 4, as the values of risk parameters “cost” and “case type”. Additionally, concerning each of the values of “cost” and “case type” extracted from the data representing the form to be printed, the job information extracting section 116 specifies a category described in the form schema. For example, by referring to the “category” field of the item number 1 shown in FIG. 4, if the value of the extracted “cost” is 0 yen or more and less than two million yen, the category A is specified, and if the value of the extracted “cost” is two million yen or more, the category B is specified. Also, by referring to the “category” field of the item number 2 shown in FIG. 4, if the value of the extracted “case type” is “new” or “cancellation”, the category A is specified, and if the value of the extracted “case type” is “repeat”, the category B is specified. The job information extracting section 116 supplies the values of the risk parameters extracted from the data representing the form to be printed and the specified categories for the individual risk parameters to the job information registration section 120.

In step S16, the job information registration section 120 specifies a due date for a job which involves handling of the form to be printed. In step S16, as described with reference to FIG. 2, a due date may be specified in accordance with a decision rule which has been set for the type of form to be printed, or an instruction to specify a due date may be received from a user. Alternatively, if a region in which the value of a due date is indicated has been specified as part of job information in accordance with the form schema, and data representing the region has been extracted from the form to be printed in step S14, the value of the due date may be specified as the due date. In this specific example, the values of the “cost” and “case type” are extracted from the form to be printed in accordance with the form schema shown in FIG. 4, and a date seven days after a current date, which is the date of printing, is set as the due date.

Upon specifying the due date, in step S18, the job information registration section 120 registers the job information and the due date in the job information storage section 130. In this example, since one form is used for one job, the document ID assigned to the form to be printed in step S10 is used as the task ID for identifying the job case. The job information registration section 120 registers the job information extracted in step S14 and the due date specified in step S16 in the job information storage section 130 in association with the task ID (document ID). In this example, a current date is also registered in the job information storage section 130 as the date of printing in association with the task ID. The table shown in FIG. 6 described above is a specific example of data contents of the job information storage section 130 obtained as a result of registration in step S18.

In step S20, the print instructing section 114 of the printing processor 110 instructs the printer 30 to perform printing by superposing the document ID on the data representing the form to be printed. For example, the print instructing section 114 instructs the printer 30 to convert the document ID assigned to the form to be printed in step S10 into a computer readable code, such as a barcode, and to superpose the converted code on the data representing the form to be printed, and to print the form on paper. In response to this instruction, the printer 30 prints the form including the document ID. A specific example of the printed form is shown in FIG. 5.

After step S20, the process shown in FIG. 8 is ended. Concerning the form which has been printed by executing the process shown in FIG. 8, job information, date of printing, and due date extracted from the data representing the form are registered in the job information storage section 130.

The process shown in FIG. 8 is merely an example of a process performed by the management server 10 that has received a request to print a form. The order in which steps S10 through S20 are executed may be changed. For example, the processing for assigning the document ID in step S10 may be executed at any time before the processing for registering job information and a due date in step S18 and the processing for giving an instruction to print a form in step S20. Additionally, the processing for giving an instruction to print a form in step S20 may be executed at any time as long as the document ID has been assigned.

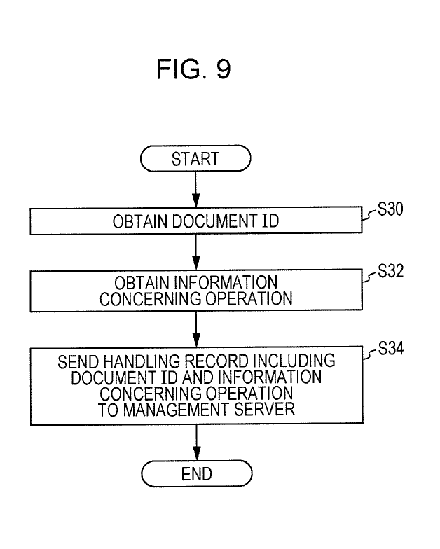

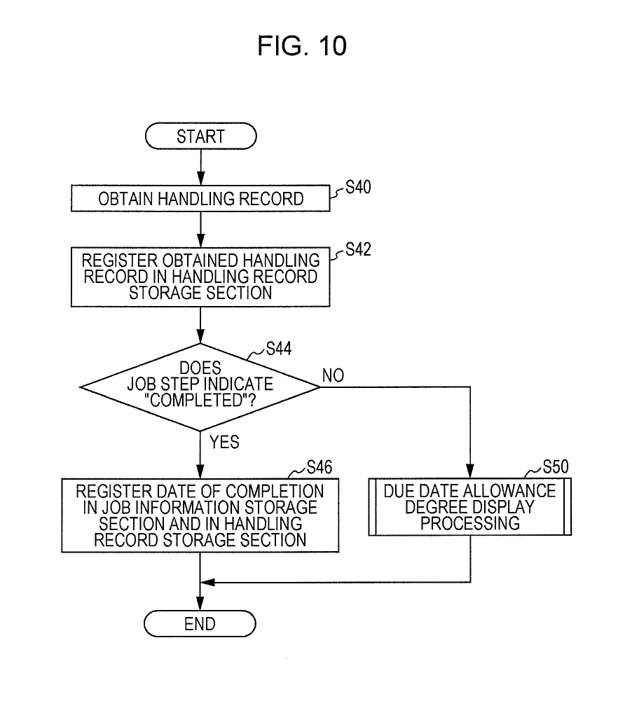

The form printed in accordance with the process shown in FIG. 8 is circulated among operators to which individual work steps of the job are assigned. Then, each operator gives an instruction to register an operation history (handling record) concerning an operation performed on the form in the management server 10. A description will be given below, with reference to FIGS. 9 and 10, of an example of a process executed by the information management system of this exemplary embodiment when registering a handling record.

FIG. 9 is a flowchart illustrating an example of a process executed by the terminal 20 when registering a handling record. Upon receiving an instruction to register a handling record of a form from a user, the terminal 20 starts the process shown in FIG. 9.

Referring to the flowchart of FIG. 9, in step S30, the terminal 20 first obtains a document ID assigned to a form by using a reader (not shown). For example, a user causes the terminal 20 to read a code representing the document ID printed on the form by using a reader connected to the terminal 20 so that the terminal 20 obtains the document ID representing the read code from the reader.

Then, in step S32, the terminal 20 obtains information concerning an operation to be performed on a form, for example, in the following manner. The terminal 20 displays in a display device (not shown) a list of job steps that may be performed in a job which involves handling of the form, and also displays in the display device information instructing a user to select one of the job steps in the list. The user checks the list and selects one of the job steps by using an input device (not shown), such as a mouse and a keyboard. Alternatively, as described above, a decision may be made in advance concerning which job step is assigned to which operator, and the association of the user IDs of the operators with the types of operations may be decided in advance. In this case, job steps are automatically decided. In any one of the manners described above, the terminal 20 obtains a job step. The terminal 20 also obtains a current date from the system clock of the terminal 20, and sets the obtained date as the date of operation on which an operation corresponding to the selected job step is performed on the form.

Then, in step S34, the terminal 20 sends a handling record including the document ID obtained in step S30 and information concerning the operation obtained in step S32 to the management server 10. After step S34, the process shown in FIG. 9 is ended.

Upon receiving the handling record sent from the terminal 20 in step S34 of FIG. 9, the management server 10 starts a process shown in FIG. 10.

Referring to the flowchart of FIG. 10, in step S40, the handling record registration section 140 of the management server 10 obtains the handling record received from the terminal 20. In this example, the handling record includes a document ID, a job step selected by a user (information indicating the type of operation performed on a form), and a date of operation, as described above.

In step S42, the handling record registration section 140 registers the handling record obtained in step S40 in the handling record storage section 150. As a specific example, the handling record registration section 140 generates a new information record in the table shown in FIG. 7, and sets values of fields in the new information record by using the information contained in the handling record obtained in step S40. For example, the handling record registration section 140 sets the values of the document ID, job step, and date of operation contained in the handling record as the values of the fields, such as the task ID, job step, and date of handling, in the new information record. Additionally, in this specific example, the handling record registration section 140 sets the values of fields, such as the date of printing, due date, RP1, and RP2 in the new information record to be the same values as those of the corresponding fields stored in the job information storage section 130 in association with the task ID of the new information record. If there is no information record including the same task ID as that for the new information record in the handling record storage section 150, the handling record registration section 140 refers to the job information storage section 130 so as to read the values of fields, such as the date of printing, due date, RP1, and RP2 associated with the task ID, and then sets the read values in the corresponding fields of the new information record. If there is another information record including the same task ID as that for the new information record in the handling record storage section 150, the handling record registration section 140 copies the values of fields, such as the date of printing, due date, RP1, and RP2, in the existing information record, and sets the copied values in the corresponding fields of the new information record.

After step S42, the handling record registration section 140 determines in step S44 whether the job step contained in the handling record registered in the handling record storage section 150 in step S42 indicates that the job which involves handling of the form to be processed has been completed. That is, in step S44, it is determined whether the job step contained in the handling record indicates “completed”.

If the job step contained in the handling record indicates “completed”, i.e., if the result of step S44 is YES, the process proceeds to step S46. In step S46, the handling record registration section 140 registers the value of the “date of handling” field in the handling record containing the job step indicating “completed” as the value of the date of completion in the job information storage section 130 and in the handling record storage section 150. In this case, the value of “date of handling” field is registered in association with the task ID of the handling record. For example, the value of the date of handling in the information record registered in step in S42 is set as the value of the “date of completion” field (see FIG. 6) associated with the task ID in the information record representing the registered handling record in the job information storage section 130. Moreover, the value of the date of handling of the handling record registered in step S42 is set as the value of the “date of completion” field in all the information records containing the task ID of the registered handling record in the handling record storage section 150. The handling record registration section 140 also calculates the value of the “number of days taken to complete a job” field in each of all the information records containing the task ID of the information record representing the handling record registered in step S42, and sets the calculated value in the “number of days taken to complete a job” field. The value of the above-described number of days is determined by calculating the number of days from the value of “date of handling” to the value of “date of completion” in each handling record. In this exemplary embodiment, the number of days taken to complete a job is calculated as follows. For example, if the date of handling and the date of completion are the same date, the above-described number of days is calculated as one. If the date three days after the date of handling is the date of completion, the number of days is calculated as four. However, the number of days taken to complete a job may be calculated by subtracting the value corresponding to the date of handling from the value corresponding to the date of completion. In this case, if the date of handling and the date of completion are the same date, the number of days is calculated as 0, and if the date three days after the date of handling is the date of completion, the number of days is calculated as three.

If the job step contained in the handling record does not indicate “completed”, i.e., if the result of step S44 is NO, the process proceeds to step S50. The handling record registration section 140 supplies such information to the due date allowance degree calculator 160. Upon receiving this information, in step S50, the due date allowance degree calculator 160 performs due date allowance degree display processing, together with the display controller 170. Details of the due date allowance degree display processing will be given later.

After step S46 or step S50, the process shown in FIG. 10 is ended.

After performing an operation on each form which has been printed together with a document ID according to the process shown in FIG. 8, a user gives an instruction to register a handling record, and then, the terminal 20 and the management server 10 perform the processes shown in FIGS. 9 and 10, respectively. As a result, in the handling record storage section 150, history information indicating which job steps were performed on which handling date for individual forms is stored. Additionally, concerning a form for which an associated job has been completed, the date of completion of a job is registered in the job information storage section 130 and the handling record storage section 150. Concerning a form for which an associated job has been completed, the number of days taken from a date of handling of the form in each job step to a date of completion of the job is registered in the handling record storage section 150. By using the above-described number of days which has been registered in this manner, the due date allowance degree display processing in step S50 of FIG. 10 is executed.

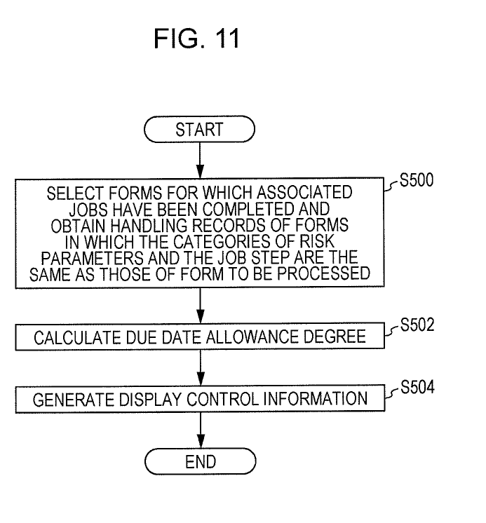

FIG. 11 illustrates an example of details of the due date allowance degree display processing in step S50 of FIG. 10. The process shown in FIG. 11 is executed for the form corresponding to the handling record registered in the handling record storage section 150 in step S42 of FIG. 10.

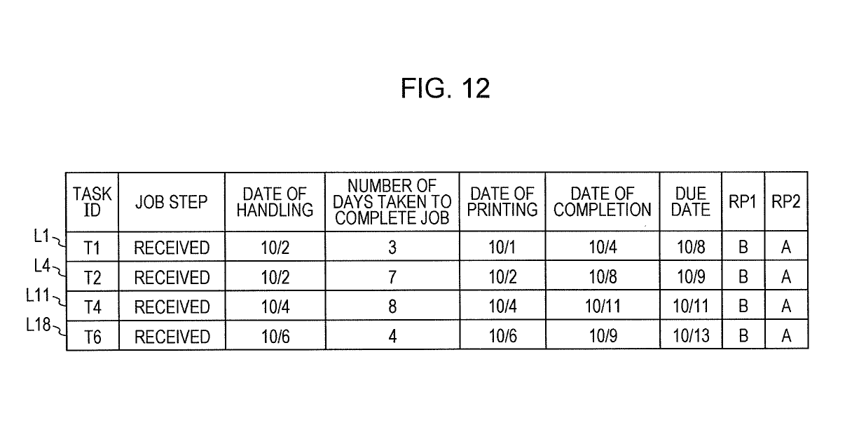

Referring to the flowchart of FIG. 11, in step S500, the due date allowance degree calculator 160 refers to the handling record storage section 150 and selects forms for which associated jobs have been completed. The due date allowance degree calculator 160 then obtains handling records of forms that satisfy conditions that the category of each of the risk parameters and the job step are the same as those of a form to be processed. A specific example of processing in step S500 will be given, assuming that the data contents shown in FIG. 7 are stored in the handling record storage section 150 and that the information record in the line L21 shown in FIG. 7 has been registered in the handling record storage section 150 in step S42 of the flowchart of FIG. 10. In this specific example, the form to be processed in step S500 is a form (task ID “T7”) corresponding to the handling record represented by the information record in the line L21 shown in FIG. 7. In step S500, the due date allowance degree calculator 160 obtains from the handling record storage section 150, among the handling records (lines L1 through L20) in which the date of completion and the number of days taken to complete a job are indicated, handling records which include the same categories as those of the risk parameters (RP1 “B”, and RP2 “A”) of the form “T7” to be processed and which include the same job step as the current job step (“received”) of the form to be processed. Information records representing the handling records obtained in this manner are shown in FIG. 12. The information records shown in FIG. 12 are information records representing the handling records in the lines L1, L4, L11, and L18 shown in FIG. 7. In the forms with the task IDs “T1”, “T2”, “T4”, and “T6” shown in FIG. 12, as well as the form with the task ID “T7”, the category of the risk parameter RP1 “cost” is “B” (0 yen or more and less than two million yen), and the category of the risk parameter RP2 “case type” is “A” (new or cancellation) (see FIGS. 4 and 6). Thus, each of the information records shown in FIG. 12 indicates how many days to complete a job which involves handling of a form that satisfies conditions that the categories of the two risk parameters are the same as those of the form with the task ID “T7” from a date on which the job step “received” of the handling record was executed.

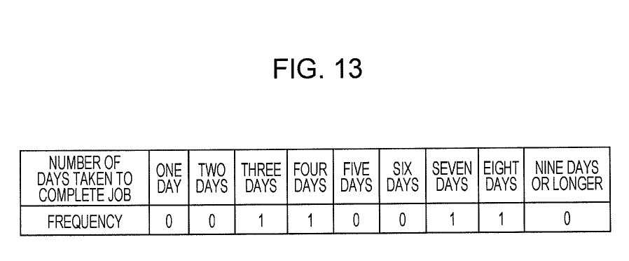

In step S502, by using the value corresponding to the above-described number of days obtained in step S500, the due date allowance degree calculator 160 calculates a due date allowance degree indicating the probability that the job which involves handling of the form to be processed will be completed by the due date. For example, the due date allowance degree calculator 160 determines a remaining number of days from a current date to a due date set for the job associated with the form. In the case of the above-described specific example in which the form with the task ID “T7” shown in FIG. 7 is a form to be processed, the due date allowance degree calculator 160 determines the remaining number of days, i.e., seven days, from the current date, i.e., the date of handling “October 8”, of the job step “received” of the task ID “T7” to the due date “October 14” of the task ID “T7”. Then, the due date allowance degree calculator 160 generates a frequency distribution of values of the “number of days taken to complete a job” field in each of the handling records obtained in step S500. In this specific example, since the handling records shown in FIG. 12 are obtained in step S500, the frequency distribution of the values of the “number of days taken to complete a job” shown in FIG. 13 is generated. Then, by using the generated frequency distribution, the due date allowance degree calculator 160 determines a proportion of the number of cases in which the number of days is the same or less than the remaining number of days from the current date to the due date of the job associated with the form to be processed. The frequency distribution illustrated in FIG. 13 shows that the number of cases in which the associated job was completed within the remaining number of days, i.e., seven days, determined for the form with the task ID “T7” is three out of four. That is, the proportion of the number of cases in which the associated job was completed within the remaining number of days determined for the form to be processed is 75%. Thus, the due date allowance degree calculator 160 sets the value 75% as the due date allowance degree. The due date allowance degree calculator 160 supplies the determined due date allowance degree to the display controller 170.

In step S504, the display controller 170 generates display control information used for displaying the due date allowance degree determined in step S502 in a display device of the terminal 20. The display controller 170 sends the generated display control information to the terminal 20 that has sent the handling record of the form to be processed to the management server 10. Upon the terminal 20 receiving the display control information, the due date allowance degree of the form is displayed in the terminal 20. After step S504, the due date allowance degree display processing shown in FIG. 11 is ended.

The above-described due date allowance degree display processing shown in FIG. 11 is executed when a handling record of a form is registered, and a due date allowance degree is displayed in the terminal 20 that has sent the handling record of that form to the management server 10. Accordingly, by executing the due date allowance degree display processing shown in FIG. 11, information, which serves as a basis for predicting whether a job associated with a certain form will be completed by a due date, is provided to a user who has performed an operation of a job step assigned to the user and who has given an instruction to register a handling record of the job step. If it is likely that the job associated with the form will not be completed within the due date, the user may proceed with handling of the form with high priority, or may inform an operator that has requested the circulation of the form of such circumstances. The user may send the contents of the form by e-mail before sending a paper form.

A user who has given an instruction to register a handling record of a form, i.e., a user who checks a due date allowance degree obtained as a result of the process shown in FIG. 11, does not have to identify a route of circulation of the form. The user receives a due date allowance degree for the form by merely instructing the management server 10 to register a handling record indicating an operation of a job step assigned to the user.

In the above-described description of the process shown in FIG. 11, in the specific example discussed with reference to FIGS. 7, 12, and 13, only one due date allowance degree is calculated. More specifically, among forms for which a associated job has been completed, forms which satisfy conditions that the categories of the risk parameters RP1 and RP2 and the job step are the same as those of a form to be processed are selected. By using values of the “number of days taken to complete a job” field described in each of the handling records of the selected forms, one due date allowance degree is calculated (steps S500 and S502). However, handling records used as references for calculating a due date allowance degree may be selected in accordance with conditions different from those of the above-described specific example. For example, instead of using handling records of forms which satisfy conditions that the categories of two risk parameters PR1 and PR2 are the same as those of a form to be processed, a handling record of a form which satisfies conditions that the category of each of the two risk parameters PR1 and PR2 is the same as that of the form to be processed may be used. Then, two due date allowance degrees concerning the risk parameters PR1 and PR2, i.e., one concerning the risk parameter RP1 and one concerning the risk parameter PR2, may be calculated. For example, calculation of two due date allowance degrees corresponding to two categories of the risk parameters RP1 and RP2 when registering the handling record (line L21) of the job step “received” of the form with the task ID “T7” shown in FIG. 7 will be considered below.

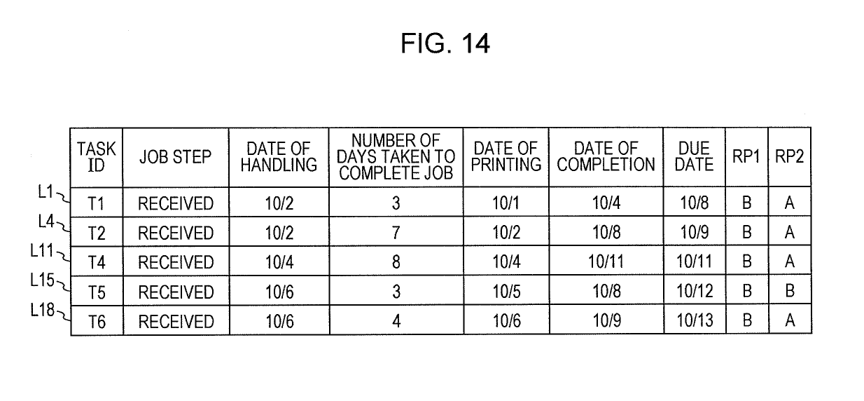

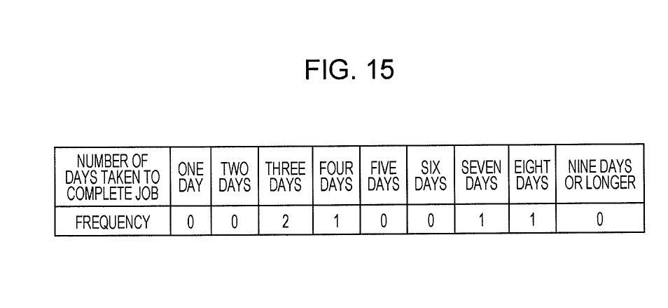

Concerning the risk parameter RP1, among handling records in which the date of completion and the number of days taken to complete a job are indicated, handling records in which the job step is “received” and the category of the risk parameter RP1 is “B” (“cost” is two million yen or more), which is the same as that of the form to be processed, are obtained. In this example, as shown in FIG. 14, handling records (lines L1, L4, L11, L15, and L18 in FIG. 7) of the job step “received” of the task IDs “T1”, “T2”, “T4”, “T5”, and “T6”, respectively, are obtained. A frequency distribution of the values of the “number of days taken to complete a job” field concerning the handling records is generated, as shown in FIG. 15. The frequency distribution illustrated in FIG. 15 shows that the number of cases in which the job was completed within the remaining number of days, i.e., seven days, from the date of handling of the job step “received” to the due date of the job associated with the form “T7” is four out of five. Accordingly, the due date allowance degree corresponding to the category of the risk parameter RP1 is 80%.

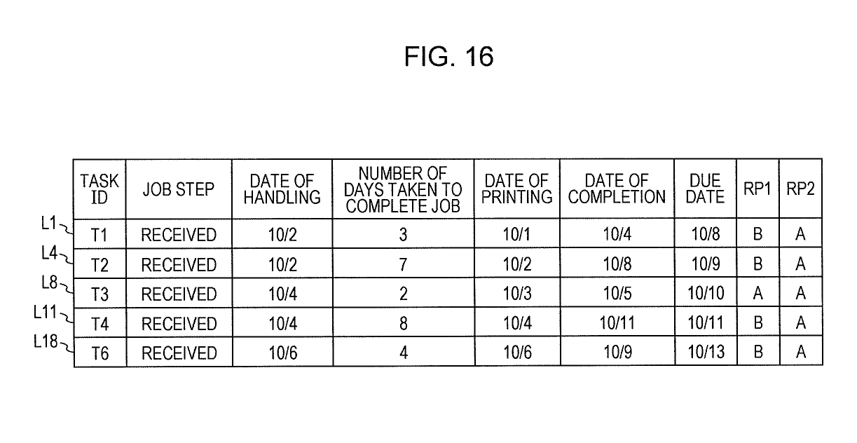

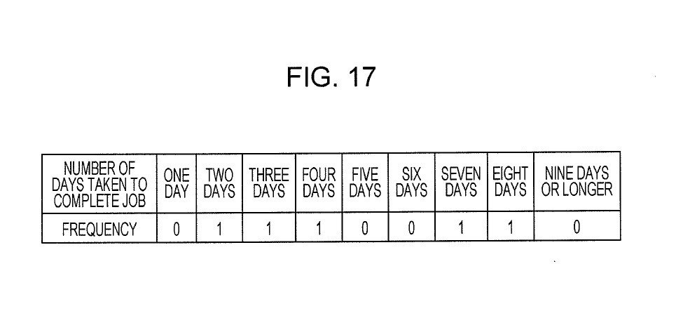

Concerning the risk parameter RP2, among handling records in which the date of completion and the number of days taken to complete a job are indicated, handling records in which the job step is “received” and the category of the risk parameter RP2 is “A” (“case type” is new or cancellation), which is the same as that of the form to be processed, are obtained. In this example, as shown in FIG. 16, handling records (lines L1, L4, L8, L11, and L18 in FIG. 7) of the job step “received” of the task IDs “T1”, “T2”, “T3”, “T4”, and “T6”, respectively, are obtained. A frequency distribution of the values of the “number of days taken to complete a job” field in the handling records is generated, as shown in FIG. 17. The frequency distribution illustrated in FIG. 17 shows that the number of cases in which the job was completed within the remaining number of days, i.e., seven days, from the date of handling of the job step “received” to the due date of the job associated with the form “T7” is four out of five. Accordingly, the due date allowance degree corresponding to the category of the risk parameter RP2 is 80%.

If the due date allowance degree calculator 160 has calculated two due date allowance degrees corresponding to the categories of the risk parameters RP1 and RP2, as in the above-described example, the display controller 170 generates display control information used for displaying the due date allowance degrees in association with the categories.

Alternatively, due date allowance degrees may be calculated as follows. Handling records are obtained on the basis of a job step and categories of risk parameters from the handling record storage section 150 as described above. Then, the obtained handling records may further be drilled down in accordance with other conditions, thereby calculating due date allowance degrees. In other words, the obtained handling records may be grouped in accordance with other conditions, and a due date allowance degree may be calculated for each group. An example of grouping conditions is the presence or the absence of a specific job step in each of the handling records. For example, the obtained handling records are grouped depending on whether the job step “returned” was performed for a form with a task ID corresponding to each of the obtained handling records. More specifically, as in the above-described specific example, when registering the handling record of the job step “received” of the form with the task ID “T7” in the handling record storage section 150, the information records representing the handling records shown in FIG. 12 are obtained. Among the forms with the task IDs “T1”, “T2”, “T4”, and “T6” corresponding to the obtained handling records, forms including handling records in which the job step is “returned” are two forms with the task IDs “T2” and “T4” (see lines L5 and L12 in FIG. 7). By referring to the “number of days taken to complete job” field described in the handling records of the forms with the task IDs “T2” and “T4” (see lines L4 and L11 in FIG. 12) in which the job step “returned” has been performed, it can be seen that the number of cases in which the associated job was completed within the remaining number of days, i.e., seven days, from the date of handling of the job step “received” to the due date of the job associated with the form “T7” is one out of two. Accordingly, the due date allowance degree in this example is 50%. On the other hand, by referring to the “number of days taken to complete a job” field described in the handling records of the forms with the task IDs “T1” and “T6” (see lines L1 and L18 in FIG. 12) in which the job step “returned” has not been performed, it can be seen that the number of cases in which the associated job was completed within seven days is two out of two. Accordingly, the due date allowance degree in this case is 100%. Thus, in the example in which the information records representing the handling records shown in FIG. 12 are obtained, the display controller 170 causes the terminal 20 to display the following information. That is, the information indicates that the due date allowance degree obtained from the handling records of the forms for which the job step “returned” was performed is 50%, while the due date allowance degree obtained from the handling records of the forms for which the job step “returned” was not performed is 100%. When obtaining the handling records shown in FIGS. 14 and 15, as in the case of the example shown in FIG. 12, the obtained handling records may be grouped depending on whether the job step “returned” was performed for a form with a task ID corresponding to each of the obtained handling records. Then, on the basis of the values of the “number of days taken to complete a job” described in the handling records in each group, a due date allowance degree may be determined.

Conditions for selecting handling records which are used as references for calculating due date allowance degrees and conditions for drilling down the selected handling records may be determined in accordance with input from a user. For example, instead of step S500 in FIG. 11, the due date allowance degree calculator 160 may receive conditions for selecting handling records through input from a user and may obtain handling records that satisfy the input conditions from the handling record storage section 150. Receiving of input from a user may be performed as follows. The due date allowance degree calculator 160 first requests the display controller 170 to send display control information to the terminal 20. The display control information is used for displaying information indicating an instruction for a user to input conditions for selecting handling records used as references for calculating due date allowance degrees. In this case, information to be displayed in accordance with the display control information may indicate an instruction to specify at least one of plural risk parameters. Then, such information is displayed in a display device of the terminal 20, and upon checking the information, a user of the terminal 20 inputs conditions and the terminal 20 returns the conditions input from the user to the management server 10. Then, the due date allowance degree calculator 160 of the management server 10 obtains handling records that satisfy the conditions input from the user from the handling record storage section 150, and then calculates due date allowance degrees by using the values of the “number of days taken to complete a job” field described in each of the obtained handling records. For example, it is now assumed that information indicating an instruction for a user to specify at least one of plural risk parameters is displayed in the display device of the terminal 20 in accordance with the display control information and that the risk parameter specified by the user is received by the management server 10. Then, the due date allowance degree calculator 160 obtains, among handling records of forms which satisfy conditions that the category of the risk parameter specified by the user is the same as that of a form to be processed, handling records in which the date of completion and the number of days taken to complete a job are indicated and in which the job step is the same as that of the current job step of the form to be processed. The due date allowance degree calculator 160 may further receive input of conditions for drilling down the obtained handling records from the user, and may group the handling conditions in accordance with the input conditions. Then, the due date allowance degree calculator 160 may calculate due date allowance degrees for individual groups. Receiving of input of conditions for drilling down handling records may be performed as in receiving of input of conditions for selecting handling records.

In the process described with reference to FIGS. 10 and 11, when registering a handling record of a form, a due date allowance degree for the form is calculated and displayed. Calculation and display of a due date allowance degree for a form may be performed, not when registering a handling record of the form, but when printing the form. In this case, after printing a form in step S20 of FIG. 8, the due date allowance degree display processing shown in FIG. 11 is executed by using the printed form as a form to be processed. In this example, in step S500, handling records of forms which satisfy conditions that the categories of risk parameters are the same as those of the form to be processed and that the date of completion is indicated are obtained from the handling record storage section 150. In step S502, the number of days from the “date of printing” to the “date of completion” of the form corresponding to each of the handling record is determined, and the frequency distribution of the values of the “number of days taken to complete a job” is generated. Then, the due date allowance degree is calculated. By using the values of the number of days from the date of printing to the date of completion, a due date allowance degree indicating the probability that a job which involves handling of the printed form will be completed by the due date is calculated.

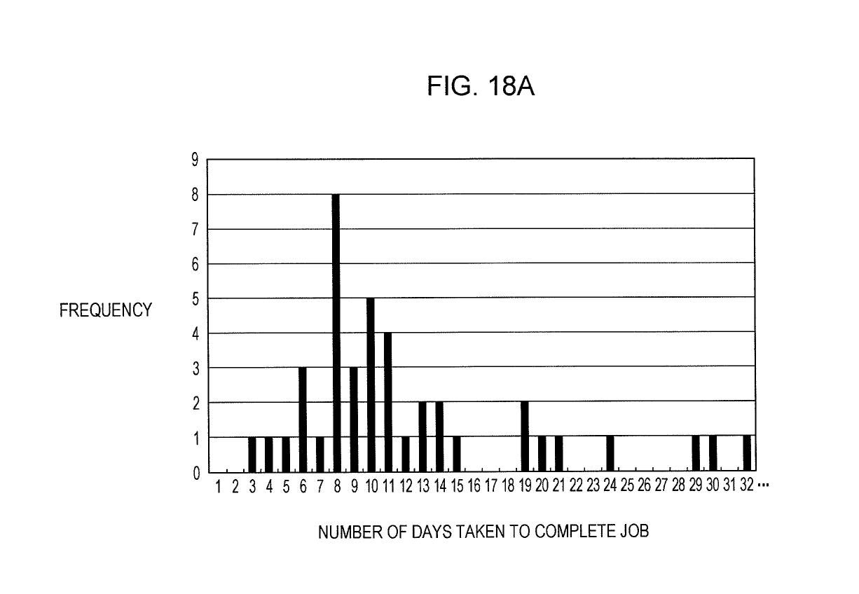

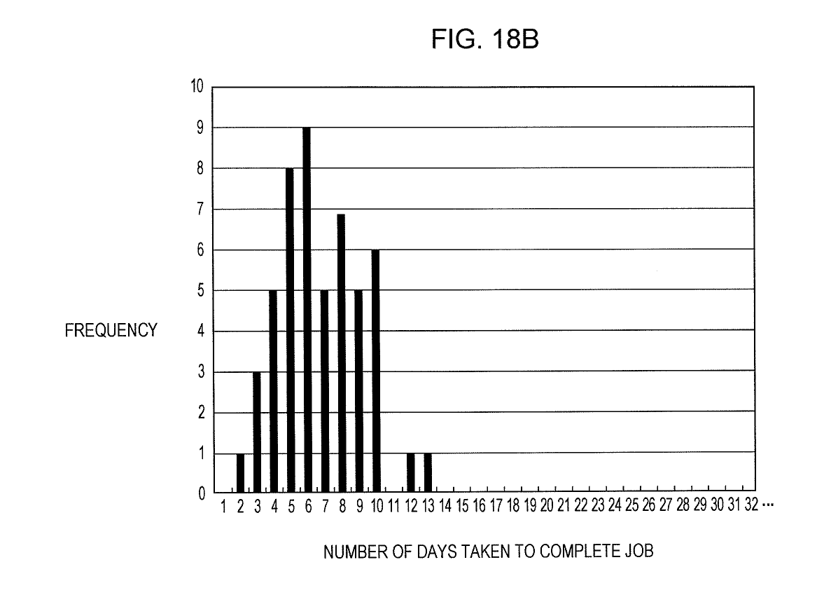

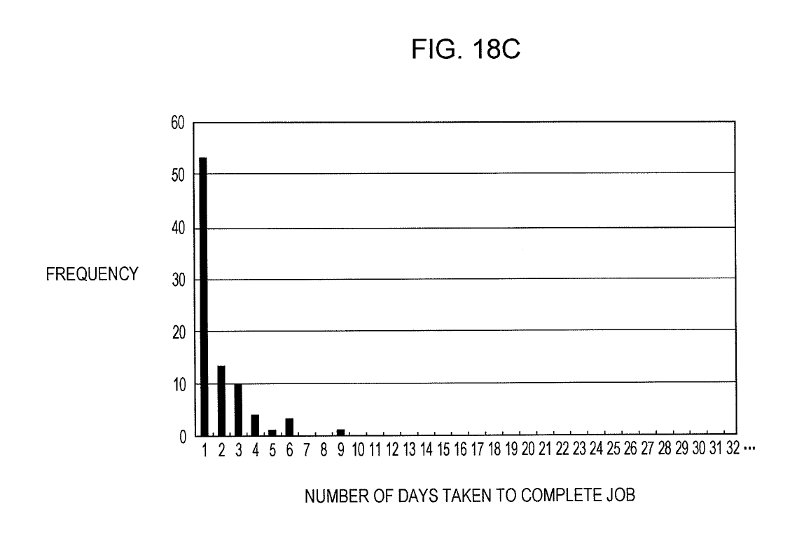

In the above-described examples of this exemplary embodiment, forms are classified in accordance with values of risk parameters, which serve as information items that influence a route of circulation of the form. Then, handling records which have already been registered are selected in accordance with the categories and are used for calculating a due date allowance degree. This is because it has been proved, from actual performance of jobs which handle forms, that the number of days taken to complete a job varies depending on the route of circulation of a form. As one specific example, FIGS. 18A, 18B, and 18C each illustrate a frequency distribution of the values of the number of days taken from a date of reception to a date of settlement of each of written proposals for approval which were actually circulated in an organization. The types of proposals described in the written proposals are used as risk parameters, and three categories are defined in accordance with the values of the parameters. FIGS. 18A, 18B, and 18C each illustrate a frequency distribution of the values of the number of days taken to complete a job to obtain an approval for each of the written proposals which belong to one of the three categories. It is noted that the types of proposals may influence the route of circulation of written proposals for approval. FIGS. 18A, 18B, and 18C show that the features of the frequency distributions of the written proposals associated with the three categories differ from one another.

In this exemplary embodiment, in addition to the above-described examples, various modifications may be made. In the above-described examples, concerning a form including a handling record to be registered or a form to be printed, a due date allowance degree indicating the probability that a job which involves handling of the form will be completed by a due date is calculated and output. In one modification of the exemplary embodiment, instead of a due date allowance degree, a value indicating the probability that a job which involves handling of a form to be processed will not be completed by a due date may be calculated and output. In this modification, in a manner similar to calculation of a due date allowance degree in the above-described examples, information records representing handling records which are used as references for calculating the above-described probability are obtained from the handling record storage section 150, and a frequency distribution of the values of the “number of days taken to complete a job” field is generated. Then, the proportion of the number of cases in which the number of days taken to complete a job that exceeds the remaining number of days before a due date of a form to be processed is calculated and output. One specific example will be given, assuming that the form with the task ID “T7” in the line L21 shown in FIG. 7 is a form to be processed and that the frequency distribution shown in FIG. 13 is generated from the information records shown in FIG. 12. The number of cases in which the associated job was not completed within the remaining number of days, i.e., seven days, determined for the form to be processed is one out of four. In this specific example, the management server 10 calculates a value indicating the probability that the job will not be completed by the due date for the form with the task ID “T7” and outputs the calculated value (25%=(¼)×100).

In the above-described examples of this exemplary embodiment, when registering a handling record, a user inputs information indicating the type of operation performed on a form by using the terminal 20. In one modification of the exemplary embodiment, the types of operations may be assigned to the terminals 20 in advance. Then, the assigned operation is included in a handling record, and the handling record is sent from a specific terminal 20 to the management server 10. For example, the types of operations may be assigned to the terminals 20 in advance, such as a job step “received” is assigned to the terminal 20a and a job step “approved” is assigned to the terminal 20b, so that the terminals 20 send handling records indicating specific types of operations to the management server 10 and register the handling records in the management server 10. In this modification, when registering a handling record, without receiving input of a type of operation from a user, the terminal 20 includes information indicating a job step assigned to the terminal 20, together with a current date, in a handling record, and then sends the handling record to the management server 10. In another modification, types of operations may be assigned to specific users, such as a job step “received” is assigned to user A and a job step “approved” is assigned to user B, so that handling records including specific types of operations are sent to the management server 10 and are registered in the management server 10.

In the above-described examples of this exemplary embodiment, when printing a form, the management server 10 assigns a document ID to the form to be printed. In one modification of the exemplary embodiment, when forming an e-form, the terminal 20 may assign a document ID to the form. In this modification, a print request includes a document ID together with form data, and the management server 10 performs processing similar to the above-described processing in the exemplary embodiment by using the document ID contained in the print request.

In the above-described examples of this exemplary embodiment, a document ID, which is superposed on form data and printed, is a computer readable code. In one modification of the exemplary embodiment, a character string (including at least one of characters, numerics, and signs) representing a document ID may be printed, together with form data, on paper by using a font suitable for optical character recognition (OCR). Alternatively, an integrated circuit (IC) tag recording a document ID therein may be attached to paper on which form data is printed. If a character string representing a document ID is printed on paper, an OCR device may be connected to the terminal 20 to read the document ID. If an IC tag recording a document ID therein is attached to a printed form, an IC tag reader may be connected to the terminal 20 to read the IC tag.

Specific formats representing information to be stored in various storage sections of the management server 10 are not restricted to the above-described formats. For example, in the table shown in FIG. 4, which is an example of a form schema stored in the form schema storage section 100, item numbers may be omitted. Additionally, a form schema may be described in a format different from the table format shown in FIG. 4. For example, contents similar to those in the table shown in FIG. 4 may be described in an eXtensible Markup language (XML) format, and a file including such contents may be used as a form schema.

In the above-described examples of this exemplary embodiment, categories of risk parameters are specified as follows. Conditions for classifying risk parameters are described in a form schema (see FIG. 4), and when the values of risk parameters are extracted from data representing a form to be printed, categories corresponding to the extracted values are specified by referring to the form schema, and are registered in the job information storage section 130 (see FIG. 6). In one modification of the exemplary embodiment, categories corresponding to the values of risk parameters may be specified when selecting handling records used as references for calculating a due date allowance degree. In this modification, conditions for classifying risk parameters are stored separately from a form schema, and when printing a form, only extraction of the values of risk parameters and registration of the values of risk parameters in the job information storage section 130 are performed, and categories are not registered. Then, when selecting handling records used as references for calculating a due date allowance degree for a form to be processed, the conditions for classifying risk parameters are checked, and the categories corresponding to the values of risk parameters which have been registered in the job information storage section 130 in association with the task IDs of the forms are specified for the form to be processed and forms for which the date of completion has been registered. After specifying the categories corresponding to the values of the risk parameters for each form, selection of handling records and calculation of a due date allowance degree are performed by using the specified categories, in a manner similar to the above-described examples of this exemplary embodiment.

In the handling record storage section 150, among the items of the table shown in FIG. 7, registration of the values of the items other than the task ID, job step, and date of handling may be omitted. If the task ID, job step, and date of handling only are registered in the handling record storage section 150, the values of the other items, such as the date of completion and the values of risk parameters, of a form corresponding to a certain handling record, may be specified by referring to the job information storage section 130 by using the task ID as a key. The number of days from a date of handling of a job step contained in a specific handling record to a date of completion may be obtained when calculating a due date allowance degree, by determining the number of days from the date of handling described in the handling record to the date of completion which has been registered in the job information storage section 130 in association with the task ID of the handling record.

In the above-described examples of this exemplary embodiment, a date of printing of a form, a due date of a job that involves handling of a form, a date of handling contained in a handling record of a job, and a date of completion of a job are all indicated by the date. In one modification of the exemplary embodiment, not only the date, but also the time may be specified and recorded for a date of printing, a date of handling, etc. For example, when registering a date of printing, the management server 10 may obtain, not only a date, but also a time at which printing was performed, from the system clock and register the date and time in the job information storage section 130. A date and a time may also be specified for a due date. Additionally, when registering a handling record, the terminal 20 may obtain, not only a date of operation, but also a time of operation, from the system clock, and include the date and time in a handling record, and then send the handling record to the management server 10. In this modification, when calculating a due date allowance degree, instead of using the number of days taken to complete a job, by using the time taken from the date and time at which a form was printed or the date and time at which a specific job step was handled to the date and time at which the job was completed, a frequency distribution may be generated.

In the above-described examples of this exemplary embodiment, when printing an e-form on paper, job data is extracted from data representing a form to be printed, and also, a document ID is superposed on the form. In one modification of the exemplary embodiment, instead of printing an e-form on paper, a new e-form may be generated by converting the file format of the e-form. At this time, job data may be extracted and registered, as in the above-described examples. For example, the file format of an e-form generated by using a certain document processing application may be converted into a predetermined format, which serves as a circulation file format, and then, the converted e-form may be circulated. The circulation file format may be a file format which is protected from being edited using a document processing application, e.g., a portable document format (PDF). Such an e-format may be circulated as a file attached to e-mail. The document ID assigned to an e-form may be contained in attribute information concerning the e-form. By using the document ID contained in the attribute information concerning the e-form, processing of the above-described examples and modifications of this exemplary embodiment may be performed in a manner described above.

In the above-described examples and modifications of this exemplary embodiment, one form is used for one job. However, in the above-described examples and modifications of this exemplary embodiment, plural forms may be used for one job. In this case, form schemas corresponding to individual forms may be defined in advance and registered in the form schema storage section 100. In this modification, a task ID for identifying a job case is generated, separately from document IDs assigned to individual forms, and the document IDs of the plural forms handled in this job case are registered in the job information storage section 130 in association with the task ID. In this modification, a due date of the job is registered in the job information storage section 130 in association with the task ID, as in the above-described examples and modifications of this exemplary embodiment. In this modification, the values of different risk parameters may be extracted from each of plural forms used for one job. The values of the risk parameters extracted from the individual forms may be registered in the job information storage section 130 in association with the task ID corresponding to the document IDs of the forms. Handling records of the individual forms are registered in the handling record storage section 150 in association with the document IDs of the forms. Concerning a date of completion, conditions that a handling record be considered as completion of a job (e.g., when a specific operation is performed on a specific form, a job is considered to be completed) may be set in advance, and when a handling record that satisfies such conditions is registered in the handling record storage section 150, the date at which the handling record was registered in the job information storage section 130 is registered as a date of completion in association with the task ID corresponding to the document ID of the handling record. Calculation of a due date allowance degree may be performed in a manner similar to the above-described examples and modifications of this exemplary embodiment by referring to handing records of each form, the task ID corresponding to the document ID of each form, and the date of completion associated with each task ID.

In the above-described examples and modifications of this exemplary embodiment, a due date allowance degree is calculated by determining the number of days from a date of printing or a date of handling described in a handling record to a date of completion. When determining the number of days taken to complete a job, instead of calculating the number of days by a simple subtraction, only working days of an organization which conducts a job that involves handling of a form to be processed are counted from the number of days from a date of printing or a date of handling to a date of completion. In other words, the number of days taken to complete a job may be calculated by excluding non-working days of the organization. If the number of days taken to complete a job is determined by counting only working days of an organization, calendar information including information indicating whether each day is a working day or a non-working day may be stored in advance in a storage device (not shown) of the management server 10. Then, by referring to this calendar information, only working days from the number of days from a date of printing or a date of handling to a date of completion are counted.

Some of the functions of the management server 10 in the above-described examples and modifications of this exemplary embodiment may be provided in the terminal 20.

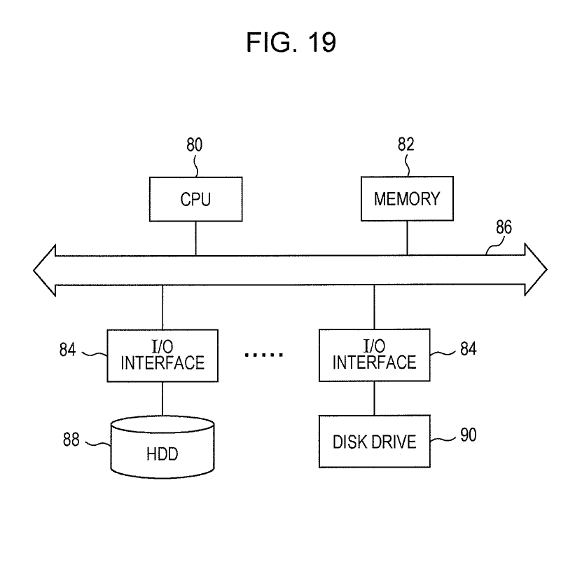

Typically, the management server 10 is implemented by executing the functions of the management server 10 or by executing a program which describes processing contents of the management server 10 in a general-purpose computer. FIG. 19 illustrates a hardware configuration of a computer. The computer has a circuit configuration including, as shown in FIG. 19, a central processing unit (CPU) 80, a memory (primary storage) 82, various input/output (I/O) interfaces 84, which are connected to one another via a bus 86. A hard disk drive (HDD) 88 or a disk drive 90 for reading various standards of portable non-volatile recording media, such as a compact disc (CD), a digital versatile disc (DVD), and a flash memory, is connected to the bus 88 via the associated I/O interface 84. The HDD 88 or the disk drive 90 serves as an external storage device for the memory 82. A program describing the processing contents of an exemplary embodiment is stored in a fixed storage device, such as the HDD 88, through the use of a recording medium, such as a CD or a DVD, or via a network, and is then installed in the computer. The program stored in the fixed storage device is read to the memory 82 and is executed by the CPU 80, thereby implementing the processing of this exemplary embodiment. The terminal 20 is also implemented in a manner similar to the processing for the management server 10.

In the above-described exemplary embodiment, the management server 10 is implemented by using one computer. However, the above-described various functions of the management server 10 may be distributed over plural computers and be executed in a distributed manner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information management apparatus comprising:
a generator that converts a format of an electronic document specified by a user so as to generate a circulation document including document identification information concerning the electronic document and contents of the electronic document;
a job information registration section that extracts, from the electronic document, from among the contents of the electronic document, an item of information, which is set in advance as an item of information that influences a time taken to complete a job which involves handling of the circulation document corresponding to the electronic document, and registers the extracted item of information as job information, together with the document identification information concerning the electronic document in association with each other, in a job information storage section, and that specifies a due date of the job which involves handling of the circulation document corresponding to the electronic document and registers the specified due date in the job information storage section in association with the document identification information concerning the electronic document;
a history information registration section that registers, upon obtaining the document identification information included in the circulation document and operation history information including information indicating a type of operation performed on the circulation document and a time of execution of the operation, the obtained document identification information and the obtained operation history information in a history information storage section in association with each other; and
an output section that refers to the job information storage section and the history information storage section and specifies document identification information which is associated with job information that is at least partially identical to the job information associated with the obtained document identification information and which is associated with operation history information indicating that a job has been completed, and that generates, by using the operation history information associated with the specified document identification information, information indicating a probability that the job that involves handling of the circulation document including the obtained document identification information will be completed by the due date or a probability that the job that involves handling of the circulation document including the obtained document identification information will not be completed by the due date, and outputs the generated information.

2. The information management apparatus according to claim 1, wherein, concerning the document identification information registered in the job information storage section by the job information registration section, the output section further generates information indicating a probability that a job which involves handling of a circulation document including the document identification information will be completed by the due date or a probability that the job which involves handling of the circulation document including the document identification information will not be completed by the due date, and outputs the generated information.

3. The information management apparatus according to claim 1, wherein by using the operation history information associated with the specified document identification information, the output section determines the number of circulation documents that satisfy conditions that a time taken from execution of an operation of a type identical to the type of operation described in the operation history information which has been obtained together with the document identification information by the history information registration section to completion of a job concerning the specified document identification information is within a remaining time from a time of execution of an operation described in the obtained operation history information to a due date of a job which involves handling of the circulation document including the obtained document identification information, and divides the determined number of circulation documents by the number of items of the specified document identification information, thereby generating information indicating a probability that a job which involves handling of the circulation document including the obtained document identification information will be completed by the due date.

4. The information management apparatus according to claim 2, wherein by using the operation history information associated with the specified document identification information, the output section determines the number of circulation documents that satisfy conditions that a time taken from execution of an operation of a type identical to the type of operation described in the operation history information which has been obtained together with the document identification information by the history information registration section to completion of a job concerning the specified document identification information is within a remaining time from a time of execution of an operation described in the obtained operation history information to a due date of a job which involves handling of the circulation document including the obtained document identification information, and divides the determined number of circulation documents by the number of items of the specified document identification information, thereby generating information indicating a probability that a job which involves handling of the circulation document including the obtained document identification information will be completed by the due date.

5. The information management apparatus according to claim 1, wherein by using the operation history information associated with the specified document identification information, the output section determines the number of circulation documents that satisfy conditions that a time taken from execution of an operation of a type identical to the type of operation described in the operation history information which has been obtained together with the document identification information by the history information registration section to completion of a job concerning the specified document identification information exceeds a remaining time from a time of execution of an operation described in the obtained operation history information to a due date of a job which involves handling of the circulation document including the obtained document identification information, and divides the determined number of circulation documents by the number of items of the specified document identification information, thereby generating information indicating a probability that a job which involves handling of the circulation document including the obtained document identification information will not be completed by the due date.

6. The information management apparatus according to claim 2, wherein by using the operation history information associated with the specified document identification information, the output section determines the number of circulation documents that satisfy conditions that a time taken from execution of an operation of a type identical to the type of operation described in the operation history information which has been obtained together with the document identification information by the history information registration section to completion of a job concerning the specified document identification information exceeds a remaining time from a time of execution of an operation described in the obtained operation history information to a due date of a job which involves handling of the circulation document including the obtained document identification information, and divides the determined number of circulation documents by the number of items of the specified document identification information, thereby generating information indicating a probability that a job which involves handling of the circulation document including the obtained document identification information will not be completed by the due date.

7. The information management apparatus according to claim 1, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

8. The information management apparatus according to claim 2, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

9. The information management apparatus according to claim 3, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

10. The information management apparatus according to claim 4, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

11. The information management apparatus according to claim 5, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

12. The information management apparatus according to claim 6, wherein a plurality of items of the specified document identification information are divided into groups in accordance with conditions specified with respect to the operation history information, and the output section generates for each of the groups, by using operation history information associated with document identification information of the corresponding group, information indicating a probability that a job which involves handling of the circulation document including the obtained document identification information will be completed by the due date or a probability that the job which involves handling of the circulation document including the obtained document identification information will not be completed by the due date, and outputs the generated information.

13. An information management method comprising:
converting a format of an electronic document specified by a user so as to generate a circulation document including document identification information concerning the electronic document and contents of the electronic document;
extracting, from the electronic document, from among the contents of the electronic document, an item of information, which is set in advance as an item of information that influences a time taken to complete a job which involves handling of the circulation document corresponding to the electronic document, and registering the extracted item of information as job information, together with the document identification information concerning the electronic document in association with each other, in a job information storage section, and specifying a due date of the job which involves handling of the circulation document corresponding to the electronic document and registering the specified due date in the job information storage section in association with the document identification information concerning the electronic document;
registering, upon obtaining the document identification information included in the circulation document and operation history information including information indicating a type of operation performed on the circulation document and a time of execution of the operation, the obtained document identification information and the obtained operation history information in a history information storage section in association with each other; and
specifying, by referring to the job information storage section and the history information storage section, document identification information which is associated with job information that is at least partially identical to the job information associated with the obtained document identification information and which is associated with operation history information indicating that a job has been completed, and generating, by using the operation history information associated with the specified document identification information, information indicating a probability that the job that involves handling of the circulation document including the obtained document identification information will be completed by the due date or a probability that the job that involves handling of the circulation document including the obtained document identification information will not be completed by the due date, and outputting the generated information.

14. A non-transitory computer readable medium storing a program causing a computer to execute a process, the process comprising:
converting a format of an electronic document specified by a user so as to generate a circulation document including document identification information concerning the electronic document and contents of the electronic document;
extracting, from the electronic document, from among the contents of the electronic document, an item of information, which is set in advance as an item of information that influences a time taken to complete a job which involves handling of the circulation document corresponding to the electronic document, and registering the extracted item of information as job information, together with the document identification information concerning the electronic document in association with each other, in a job information storage section, and specifying a due date of the job which involves handling of the circulation document corresponding to the electronic document and registering the specified due date in the job information storage section in association with the document identification information concerning the electronic document;
registering, upon obtaining the document identification information included in the circulation document and operation history information including information indicating a type of operation performed on the circulation document and a time of execution of the operation, the obtained document identification information and the obtained operation history information in a history information storage section in association with each other; and
specifying, by referring to the job information storage section and the history information storage section, document identification information which is associated with job information that is at least partially identical to the job information associated with the obtained document identification information and which is associated with operation history information indicating that a job has been completed, and generating, by using the operation history information associated with the specified document identification information, information indicating a probability that the job that involves handling of the circulation document including the obtained document identification information will be completed by the due date or a probability that the job that involves handling of the circulation document including the obtained document identification information will not be completed by the due date, and outputting the generated information.

15. An information management system comprising:
a converting section that converts a format of an electronic document specified by a user so as to generate a circulation document including document identification information concerning the electronic document and contents of the electronic document;
a job information registration section that extracts, from the electronic document, from among the contents of the electronic document, an item of information, which is set in advance as an item of information that influences a time taken to complete a job which involves handling of the circulation document corresponding to the electronic document, and registers the extracted item of information as job information, together with the document identification information concerning the electronic document in association with each other, in a job information storage section, and that specifies a due date of the job which involves handling of the circulation document corresponding to the electronic document and registers the specified due date in the job information storage section in association with the document identification information concerning the electronic document;
an input receiving section that receives, through input of a user, the document identification information included in the circulation document and operation history information including information indicating a type of operation performed on the circulation document and a time of execution of the operation;
a history information registration section that obtains the document identification information and the operation history information received by the input receiving section, and registers the obtained document identification information and the obtained operation history information in a history information storage section in association with each other; and
an output section that refers to the job information storage section and the history information storage section and specifies document identification information which is associated with job information that is at least partially identical to the job information associated with the obtained document identification information and which is associated with operation history information indicating that a job has been completed, and that generates, by using the operation history information associated with the specified document identification information, information indicating a probability that the job that involves handling of the circulation document including the obtained document identification information will be completed by the due date or a probability that the job that involves handling of the circulation document including the obtained document identification information will not be completed by the due date, and outputs the generated information.
